(19) United States
(12) Patent Application Publication
(10) Pub. No.: US 2022/0398490 A1
(43) Pub. Date: Dec. 15, 2022

(54) DETECTING AND PROFILING MACHINE LEARNING MODEL PREDICTIONS

(71) Applicant: International Business Machines Corporation, Armonk, NY (US)

(72) Inventors: Si Er Han, Xi'an (CN); Jing Xu, Xi'an (CN); Xue Ying Zhang, Xi'an (CN); Jing James Xu, Xi'an (CN); Xiao Ming Ma, Xi'an (CN)

(21) Appl. No.: 17/347,128

(22) Filed: Jun. 14, 2021

(51) Int. Cl. G06N 20/00; G06N 5/04

(52) U.S. Cl. CPC G06N 20/00; G06N 5/046

(57) ABSTRACT

In an approach for detecting and profiling influential predictors in a machine learning model, a processor receives a case as an input to a pre-trained model for a prediction, the prediction being based on a plurality of predictors. A processor determines a range for a predictor where the predictor varies without changing the prediction. A processor generates a data set by sampling data across the determined range of the predictor. A processor builds a predictive model with the generated data set. A processor outputs a prediction result including an insight about the range of the predictor.

### BACKGROUND

The present disclosure relates generally to the field of machine learning, and more particularly to detecting and profiling machine learning model predictions.

Predictive analytics may encompass a variety of statistical techniques from data mining, predictive modelling, and machine learning that analyze current and historical facts to make predictions about future or otherwise unknown events. In business, predictive models may exploit patterns found in historical and transactional data to identify risks and opportunities. Models may capture relationships among many factors to allow assessment of risk or potential associated with a particular set of conditions, guiding decision-making for candidate transactions. Predictive analytics may provide a predictive score (probability) for each individual (customer, employee, healthcare patient, vehicle, component, machine, or other organizational unit) in order to determine, inform, or influence organizational processes that pertain across large numbers of individuals, such as in marketing, credit risk assessment, fraud detection, manufacturing, healthcare, and government operations including law enforcement. Predictive analytics may be used in actuarial science, marketing, business management, sports, insurance, telecommunications, retail, travel, mobility, healthcare, child protection, pharmaceuticals, capacity planning, social networking, and other fields.

In many cases, a model may be chosen based on detection theory to try to guess the probability of an outcome given a set amount of input data, for example given an email determining how likely that it is spam. Models can use one or more classifiers in trying to determine the probability of a set of data belonging to another set. For example, a model might be used to determine whether an email is spam or non-spam.

### SUMMARY

Aspects of an embodiment of the present disclosure disclose an approach for detecting and profiling influential predictors in a machine learning model. A processor receives a case as an input to a pre-trained model for a prediction, the prediction being based on a plurality of predictors. A processor determines a range for a predictor where the predictor varies without changing the prediction. A processor generates a data set by sampling data across the determined range of the predictor. A processor builds a predictive model with the generated data set. A processor outputs a prediction result including an insight about the range of the predictor.

### BRIEF DESCRIPTION OF THE DRAWINGS

FIG. 1 is a functional block diagram illustrating a model prediction analysis environment, in accordance with an embodiment of the present disclosure.

FIG. 2 is a flowchart depicting operational steps of a prediction analysis module within the computing device of FIG. 1, in accordance with an embodiment of the present disclosure.

FIG. 3 illustrates an exemplary functional flowchart of the prediction analysis module within the computing device of FIG. 1, in accordance with an embodiment of the present disclosure.

FIG. 4 illustrates an exemplary functional illustration of a range determination module in the prediction analysis module within the computing device of FIG. 1, in accordance with an embodiment of the present disclosure.

FIG. 5 illustrates an exemplary functional illustration of a category determination module in the prediction analysis module within the computing device of FIG. 1, in accordance with an embodiment of the present disclosure.

FIG. 6 is a block diagram of components of the computing device in FIG. 1, in accordance with an embodiment of the present disclosure.

### DETAILED DESCRIPTION

The present disclosure is directed to systems and methods for detecting and profiling influential predictors in a machine learning model.

Embodiments of the present disclosure recognize a need to explain a prediction by a predictive model. For example, in machine learning, once a predictive model is built, one of the most important topics is to explain why a case is predicted to be a particular value/category by the predictive model. Embodiments of the present disclosure recognize a need to sample data effectively other than a random data sampling in a local interpretable model-agnostic explanation method. For example, a drawback of the local interpretable model-agnostic explanation method can be that the sampling method is totally random. The random sampling may result in that a massive number of sampled cases would be needed to get enough effective cases to build a decent predictive model. Embodiments of the present disclosure recognize a need to provide further insights about the ranges of influential predictors which could vary.

Embodiments of the present disclosure disclose an iterative method of detecting and profiling influential predictors. Embodiments of the present disclosure disclose using a fine-grained sampling strategy. Embodiments of the present disclosure disclose profiling the influential predictors by intervals where the predictors could vary without changing the predictions. Embodiments of the present disclosure disclose determining an interval for each predictor where the predictor could vary without changing the prediction. Embodiments of the present disclosure disclose generating sample cases by sampling evenly across the intervals. Embodiments of the present disclosure disclose building a predictive model with the generated cases. Embodiments of the present disclosure disclose iteratively refining the intervals until a proper stopping rule is satisfied.

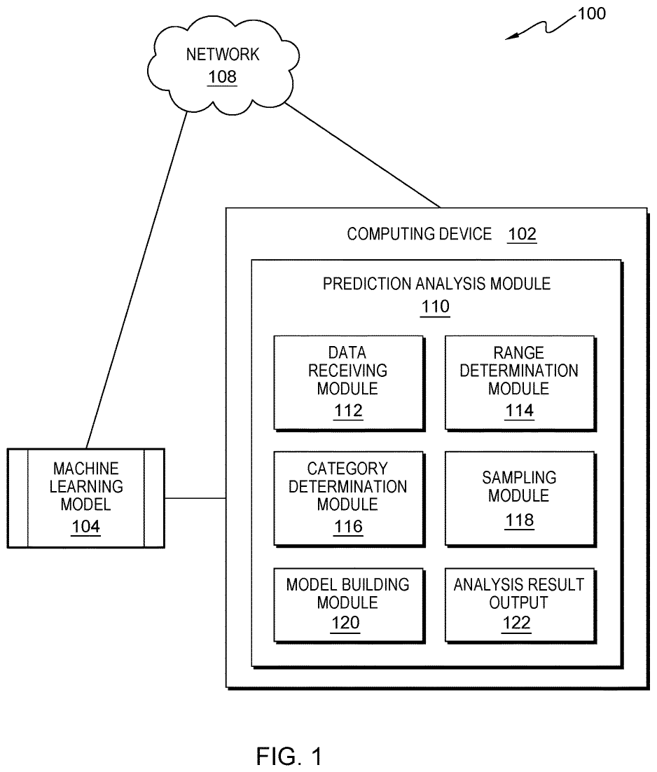

The present disclosure will now be described in detail with reference to the Figures. FIG. 1 is a functional block diagram illustrating a model prediction analysis environment, generally designated 100, in accordance with an embodiment of the present disclosure.

In the depicted embodiment, model prediction analysis environment 100 includes computing device 102, machine learning model 104, and network 108. Machine learning model 104 may be accessed through a communication network such as network 108. Machine learning model 104 may be accessed directly from computing device 102. In various embodiments of the present disclosure, machine learning model 104 may be a pre-trained predictive model. Machine learning model 104 may be a classifier. Machine learning model 104 may have a plurality of predictors to use for a prediction. Machine learning model 104 may recognize trends from data or recognize the categories that the data fits in so that when machine learning model 104 is presented with new data, machine learning model 104 can make proper predictions. When machine learning model 104 receives new data as an input, machine learning model 104 may predict a particular result based on the input. For example, in a churn prediction problem, machine learning model 104 may predict whether an individual case would move out of a collective group over a specific period based on the predictors.

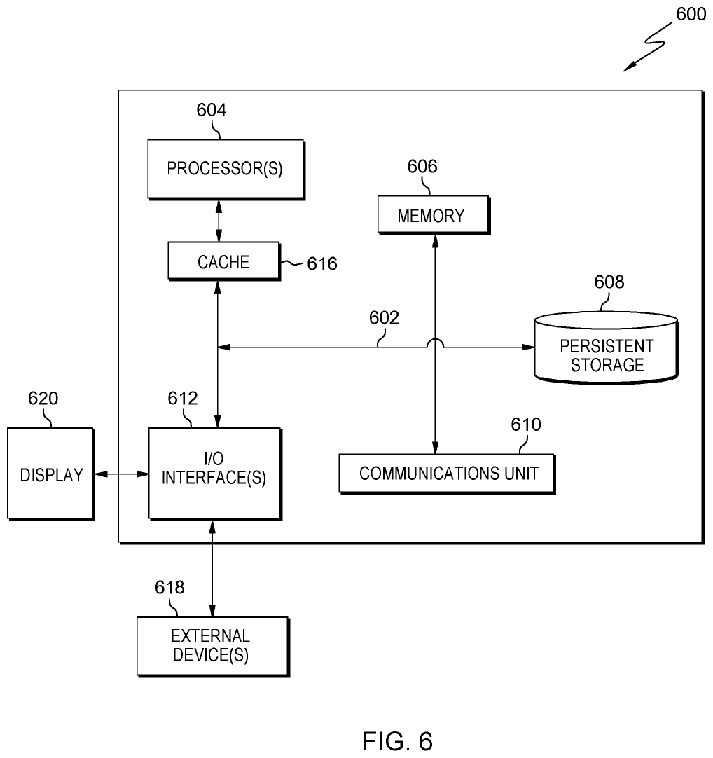

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to prediction analysis module 110 and network 108 and is capable of processing program instructions and executing authentication module 142, in accordance with an embodiment of the present disclosure. Prediction analysis module 110 may include internal and external hardware components, as depicted and described in further detail with respect to FIG. 6.

Further, in the depicted embodiment, computing device 102 includes prediction analysis module 110. In the depicted embodiment, prediction analysis module 110 is located on computing device 102. However, in other embodiments, prediction analysis module 110 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and prediction analysis module 110, in accordance with a desired embodiment of the disclosure.

In one or more embodiments, prediction analysis module 110 is configured to receive a new case (new data) as an input to machine learning model 104 for a prediction. Prediction analysis module 110 may generate simulated data around the new case under analysis. Machine learning model 104 may recognize trends from data or recognize the categories that the data fits in so that when machine learning model 104 is presented with new data, machine learning model 104 can make proper predictions. When machine learning model 104 receives new data as an input, machine learning model 104 may predict a particular result based on the input. Machine learning model 104 may have a plurality of predictors to use for the prediction.

In one or more embodiments, prediction analysis module 110 is configured to determine a range for a predictor where the predictor could vary without changing the prediction. The predictor may be a continuous predictor with intervals. Prediction analysis module 110 may detect influential predictors. Prediction analysis module 110 may generate an interval for each influential predictor. Prediction analysis module 110 may continuously refine the intervals with an iterative process. In an example, prediction analysis module 110 may determine the predictor intervals. For the predictor under process, prediction analysis module 110 may increase a value by a small amount for the predictor under process while keeping other predictors fixed with no change. If the prediction of the new case from machine learning model 104 is not changed based on the increased value, prediction analysis module 110 may continue to increase the value by a little more until the prediction of the new case is changed. When the prediction of the new case is changed, prediction analysis module 110 determines the upper boundary of the range. On the other hand, prediction analysis module 110 may determine the lower boundary in a similar way to the upper boundary by decreasing the value by a small amount. Once prediction analysis module 110 determines the upper boundary and the lower boundary, prediction analysis module 110 determines the range of the predictor intervals. In another example, for a categorical predictor, prediction analysis module 110 may simply divide into two sets according to whether the new case has the same prediction as the original one or not.

In one or more embodiments, prediction analysis module 110 is configured to generate data samples by sampling across the determined range of the predictor. Prediction analysis module 110 may effectively produce useful cases. Prediction analysis module 110 may provide valuable insights about ranges of influential predictors. Given the range determined as above, for each predictor, prediction analysis module 110 may sample data that falls within the range or not with equal probability. Prediction analysis module 110 may generate sample data randomly based on the determined range. For example, prediction analysis module 110 may generate sample data within the given range evenly. Prediction analysis module 110 may generate sample data outside the given range evenly as well. Prediction analysis module 110 may obtain a target value of the sample case by scoring the case with a predictive model. In another example, prediction analysis module 110 may take the target value as that of the nearest neighbor of the case. Prediction analysis module 110 may generate sample data repeatedly in such a sampling process until prediction analysis module 110 obtains a pre-defined number of new data samples (e.g., new cases). Prediction analysis module 110 may generate new cases by sampling evenly across the intervals (ranges).

In one or more embodiments, prediction analysis module 110 is configured to build a predictive model with the generated data samples by sampling data evenly across the ranges of influential predictors. Prediction analysis module 110 may take the most important predictors and may refine the ranges until a proper stopping rule is satisfied. Prediction analysis module 110 may rank the predictors by contribution of the predictors to the prediction. Prediction analysis module 110 may select a pre-defined number of top predictors based on a pre-defined threshold. The pre-defined threshold indicates an influence level for the prediction. Prediction analysis module 110 may build any type of predictive models if the model may provide the measure of predictor importance. Prediction analysis module 110 may select the most important predictors. Prediction analysis module 110 may select a specified number of the most important predictors. Prediction analysis module 110 may refine intervals of the selected predictors by iteration. Prediction analysis module 110 may apply a stopping rule based on an iteration number, a convergency of intervals, or a user interruption.

In one or more embodiments, prediction analysis module 110 is configured to output a prediction result through analysis result output 122. The prediction result may include valuable insights about ranges of the influential predictors. In an example why a customer is churned, prediction analysis module 110 may indicate that the measure of data usage may play the most important role. Moreover, for example, prediction analysis module 110 may show that the customer will remain churned when the data usage is, for example, in the range of [0.0, 2.6]. Accordingly, prediction analysis module 110 may suggest a particular business treatment to boost data usage of the customer to keep the customer. Prediction analysis module 110 may present the intervals of the influential predictors to provide useful insights for analysts. In some cases, such insights may be directly actionable in a marketing place.

In the depicted embodiment, prediction analysis module 110 includes data receiving module 112, range determination module 114, category determination module 116, sampling module 118, model building module 120, and analysis result output 122. In one or more embodiments, data receiving module 112 is configured to receive a new case (new data) as an input to machine learning model 104 for a prediction. Prediction analysis module 110 may generate simulated data around the new case under analysis. Machine learning model 104 may recognize trends from data or recognize the categories that the data fits in so that when machine learning model 104 is presented with new data, machine learning model 104 can make proper predictions. When machine learning model 104 receives new data as an input, machine learning model 104 may predict a particular result based on the input. Machine learning model 104 may have a plurality of predictors to use for the prediction.

In one or more embodiments, range determination module 114 is configured to determine a range for a predictor where the predictor could vary without changing the prediction. The predictor may be a continuous predictor with intervals. Range determination module 114 may detect influential predictors. Range determination module 114 may generate an interval for each influential predictor. Range determination module 114 may continuously refine the intervals with an iterative process. In an example, range determination module 114 may determine the predictor intervals. For the predictor under process, range determination module 114 may increase a value by a small amount for the predictor under process while keeping other predictors fixed with no change. If the prediction of the new case from machine learning model 104 is not changed based on the increased value, range determination module 114 may continue to increase the value by a little more until the prediction of the new case is changed. When the prediction of the new case is changed, range determination module 114 determines the upper boundary of the range. On the other hand, range determination module 114 may determine the lower boundary in a similar way to the upper boundary by decreasing the value by a small amount. Once range determination module 114 determines the upper boundary and the lower boundary, range determination module 114 determines the range of the predictor intervals. In one or more embodiments, category determination module 116 is configured to simply divide a category predictor into two sets according to whether the new case has the same prediction as the original one or not.

In one or more embodiments, sampling module 118 is configured to generate data samples by sampling across the determined range of the predictor. Sampling module 118 may effectively produce useful cases. Sampling module 118 may provide valuable insights about ranges of influential predictors. Given the range determined as above, for each predictor, sampling module 118 may sample data that falls within the range or not with equal probability. Sampling module 118 may generate sample data randomly based on the determined range. For example, sampling module 118 may generate sample data within the given range evenly. Sampling module 118 may generate sample data outside the given range evenly as well. Sampling module 118 may obtain a target value of the sample case by scoring the case with a predictive model. In another example, sampling module 118 may take the target value as that of the nearest neighbor of the case. Sampling module 118 may generate sample data repeatedly in such a sampling process until sampling module 118 obtains a pre-defined number of new data samples (e.g., new cases). Sampling module 118 may generate new cases by sampling evenly across the intervals (ranges).

In one or more embodiments, model building module 120 is configured to build a predictive model with the generated data samples by sampling data evenly across the ranges of influential predictors. Model building module 120 may take the most important predictors and may refine the ranges until a proper stopping rule is satisfied. Model building module 120 may rank the predictors by contribution of the predictors to the prediction. Model building module 120 may select a pre-defined number of top predictors based on a pre-defined threshold. The pre-defined threshold indicates an influence level for the prediction. Model building module 120 may build any type of predictive models where the model may provide the measure of predictor importance. Model building module 120 may select the most important predictors. Model building module 120 may select a specified number of the most important predictors. Model building module 120 may refine intervals of the selected predictors by iteration. Model building module 120 may apply a stopping rule based on an iteration number, a convergency of intervals, or a user interruption. In one or more embodiments, analysis result output 122 is configured to output a prediction result. The prediction result may include valuable insights about ranges of the influential predictors. In an example why a customer is churned, analysis result output 122 may indicate that the measure of data usage may play the most important role. Moreover, for example, analysis result output 122 may show that the customer will remain churned when the data usage is, for example, in the range of [0.0, 2.6]. Accordingly, analysis result output 122 may suggest a particular business treatment to boost data usage of the customer to keep the customer. Analysis result output 122 may present the intervals of the influential predictors to provide useful insights for analysts. In some cases, such insights may be directly actionable in a marketing place.

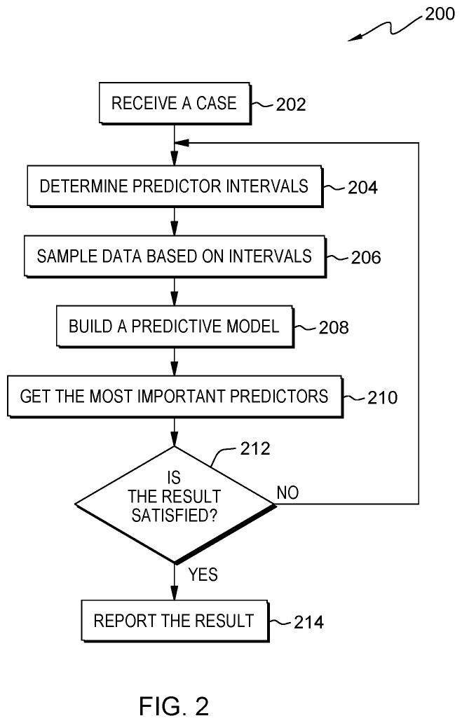

FIG. 2 is a flowchart 200 depicting operational steps of prediction analysis module 110 in accordance with an embodiment of the present disclosure.

Prediction analysis module 110 operates to receive a new case as an input to machine learning model 104 for a prediction. Prediction analysis module 110 also operates to determine a range for a predictor where the predictor could vary without changing the prediction. Prediction analysis module 110 operates to generate data samples by sampling across the determined range of the predictor. Prediction analysis module 110 operates to build a predictive model with the generated data samples by sampling data evenly across the ranges of influential predictors. Prediction analysis module 110 operates to get the most important predictors. Prediction analysis module 110 may select the most important predictors. Prediction analysis module 110 operates to output a prediction result. The prediction result may include valuable insights about ranges of the influential predictors.

In step 202, prediction analysis module 110 receives a new case (new data) as an input to machine learning model 104 for a prediction. Prediction analysis module 110 may generate simulated data around the new case under analysis. Machine learning model 104 may recognize trends from data or recognize the categories that the data fits in so that when machine learning model 104 is presented with new data, machine learning model 104 can make proper predictions. When machine learning model 104 receives new data as an input, machine learning model 104 may predict a particular result based on the input. Machine learning model 104 may have a plurality of predictors to use for the prediction.

In step 204, prediction analysis module 110 determines a range for a predictor where the predictor could vary without changing the prediction. The predictor may be a continuous predictor with intervals. Prediction analysis module 110 may detect influential predictors. Prediction analysis module 110 may generate an interval for each influential predictor. Prediction analysis module 110 may continuously refine the intervals with an iterative process. For example, prediction analysis module 110 may keep values of other predictors in the plurality of predictors fixed. Prediction analysis module 110 may increase a first initial value for an upper boundary by a pre-defined amount for the predictor under process. Prediction analysis module 110 may continue to increase the first initial value by the pre-defined amount for the predictor until the prediction of the case is changed. Prediction analysis module 110 may determine the increased value as the upper boundary of the range. Prediction analysis module 110 may decrease a second initial value of a lower boundary by a pre-defined amount for the predictor under process. Prediction analysis module 110 may continue to decrease the second initial value by the pre-defined amount for the predictor until the prediction of the case is changed. Prediction analysis module 110 may determine the decreased value as the lower boundary of the range. In an example, prediction analysis module 110 may determine the predictor intervals. For the predictor under process, prediction analysis module 110 may increase a value by a small amount for the predictor under process while keeping other predictors fixed with no change. If the prediction of the new case from machine learning model 104 is not changed based on the increased value, prediction analysis module 110 may continue to increase the value by a little more until the prediction of the new case is changed. When the prediction of the new case is changed, prediction analysis module 110 determines the upper boundary of the range. On the other hand, prediction analysis module 110 may determine the lower boundary in a similar way to the upper boundary by decreasing the value by a small amount. Once prediction analysis module 110 determines the upper boundary and the lower boundary, prediction analysis module 110 determines the range of the predictor intervals. In another example, for a categorical predictor, prediction analysis module 110 may simply divide into two sets according to whether the new case has the same prediction as the original one or not.

In step 206, prediction analysis module 110 generates data samples by sampling across the determined range of the predictor. Prediction analysis module 110 may effectively produce useful cases. Prediction analysis module 110 may provide valuable insights about ranges of influential predictors. Given the range determined as above, for each predictor, prediction analysis module 110 may sample data that falls within the range or not with equal probability. Prediction analysis module 110 may generate sample data randomly based on the determined range. For example, prediction analysis module 110 may generate sample data within the given range evenly. Prediction analysis module 110 may generate sample data outside the given range evenly as well. Prediction analysis module 110 may obtain a target value of the sample case by scoring the case with a predictive model. In another example, prediction analysis module 110 may take the target value as that of the nearest neighbor of the case. Prediction analysis module 110 may generate sample data repeatedly in such a sampling process until prediction analysis module 110 obtains a pre-defined number of new data samples (e.g., new cases). Prediction analysis module 110 may generate new cases by sampling evenly across the intervals (ranges).

In step 208, prediction analysis module 110 builds a predictive model with the generated data samples by sampling data evenly across the ranges of influential predictors. Prediction analysis module 110 may build any type of predictive models if the model may provide the measure of predictor importance. For example, prediction analysis module 110 may build the predictive model wherein the predictive model provides the measurement of predictor importance. The measure of predictor importance may be based on contribution of the predictors to the prediction. Prediction analysis module 110 may select a number of top ranked predictors based on the measurement. Prediction analysis module 110 may refine the ranges of the number of top ranked predictors with an iteration process until a stopping rule is satisfied.

In step 210, prediction analysis module 110 gets the most important predictors. Prediction analysis module 110 may rank the predictors by contribution of the predictors to the prediction. Prediction analysis module 110 may select a pre-defined number of top predictors based on a pre-defined threshold. The pre-defined threshold indicates an influence level for the prediction. Prediction analysis module 110 may select the most important predictors. Prediction analysis module 110 may select a specified number of the most important predictors. Prediction analysis module 110 may refine intervals of the selected predictors by iteration. In decision 212, prediction analysis module 110 determines whether the result of refining the intervals of the important predictors is satisfied based on a stopping rule. Prediction analysis module 110 may apply a stopping rule based on an iteration number, a convergency of intervals, or a user interruption. If prediction analysis module 110 determines that the result is not satisfied based on the stopping rule (decision 212, “NO” branch), prediction analysis module 110 continues to refine the ranges until a proper stopping rule is satisfied. If prediction analysis module 110 determines that the result is satisfied based on the stopping rule (decision 212, “YES” branch), in step 214, prediction analysis module 110 outputs a prediction result and reports the result to a user. The prediction result may include valuable insights about ranges of the influential predictors. In an example why a customer is churned, prediction analysis module 110 may indicate that the measure of data usage may play the most important role. Moreover, for example, prediction analysis module 110 may show that the customer will remain churned when the data usage is, for example, in the range of [0.0, 2.6]. Accordingly, prediction analysis module 110 may suggest a particular business treatment to boost data usage of the customer to keep the customer. Prediction analysis module 110 may present the intervals of the influential predictors to provide useful insights for analysts. In some cases, such insights may be directly actionable in a marketing place.

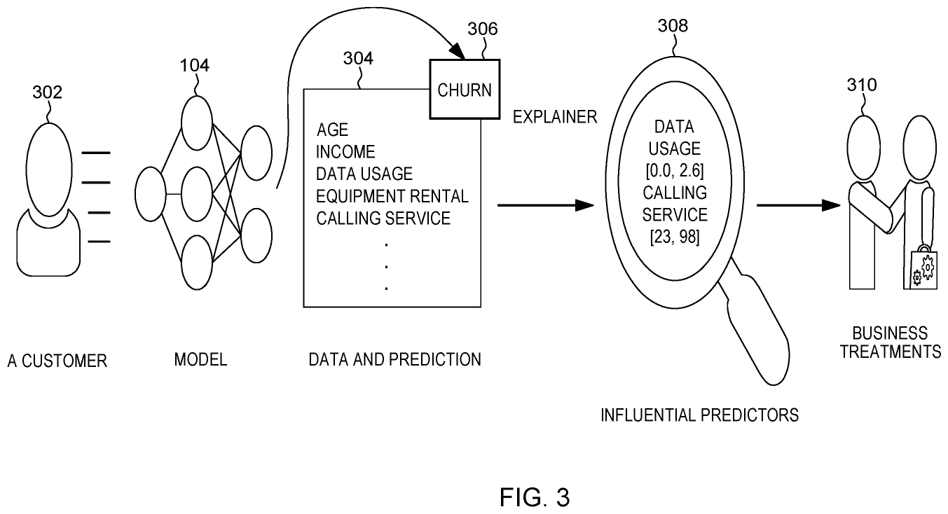

FIG. 3 illustrates an exemplary functional flowchart of prediction analysis module 110 in accordance with one or more embodiments of the present disclosure.

In the example of FIG. 3, machine learning model 104 is a pre-trained model to predict whether customer 302 is going to churn 306 from a service or not. Predictors 304 may be data information, for example, age, income, data usage, equipment rental, calling service etc. The user can disable this feature or must opt in to have their user information be obtained. The user is in control of what type of information is going to be collected and aware of how that information is going to be used. Prediction analysis module 110 may present influential predictors 398 to provide useful insights for analysts. In the example, prediction analysis module 110 may indicate that the measure of data usage may play an important role. Moreover, for example, prediction analysis module 110 may show that the customer will remain churned when the data usage is, for example, in the range of [0.0, 2.6]. Accordingly, prediction analysis module 110 may suggest business treatments 310 to boost data usage of the customer to keep the customer.

FIG. 4 illustrates an exemplary functional illustration of range determination module 114 in prediction analysis module 110 in accordance with one or more embodiments of the present disclosure.

In the example of FIG. 4, range determination module 114 determines a range for predictor 402. Predictor 402 may be a continuous predictor with intervals. Range determination module 114 may increase a value 406 by a small amount for predictor 402 under process while keeping other predictors fixed with no change. If the prediction of the new case from machine learning model 104 is not changed based on the increased value, range determination module 114 may continue to increase the value 406 by a little more until the prediction of the new case is changed. When the prediction of the new case is changed, range determination module 114 determines upper boundary 404 of the range. On the other hand, range determination module 114 may determine lower boundary 408 in a similar way to upper boundary 404 by decreasing the value by a small amount. Once range determination module 114 determines upper boundary 404 and lower boundary 408, range determination module 114 determines the range of the predictor intervals.

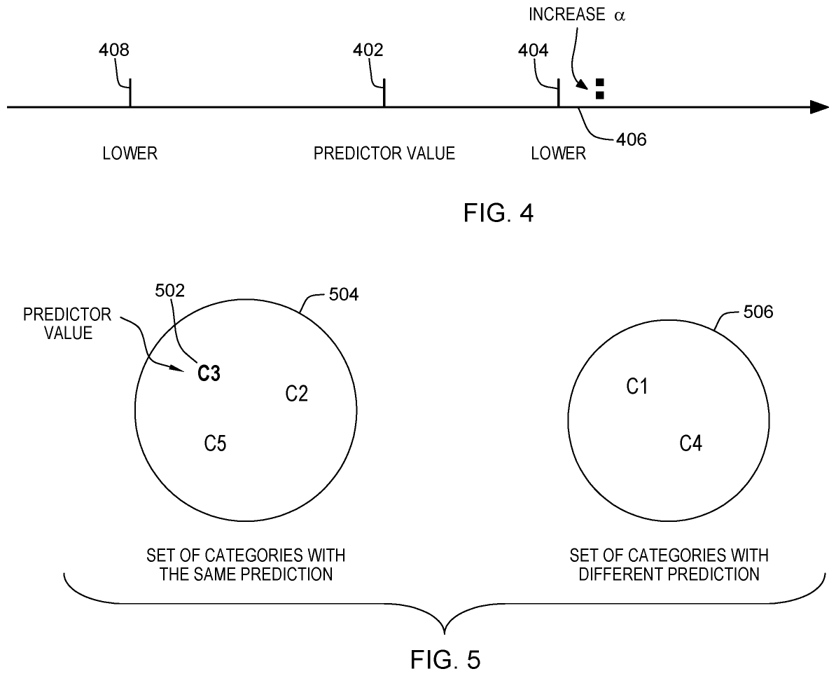

FIG. 5 illustrates an exemplary functional illustration of category determination module 114 in prediction analysis module 110 in accordance with one or more embodiments of the present disclosure.

In the example of FIG. 5, category determination module 116 may simply divide category predictors into two sets 504, 506 according to whether a new case has the same prediction as original category 502 or not. For example, category determination module 116 may put category predictors C2, C5 into set 504 as category predictors C2, C5 have the same prediction as original category 502. Category determination module 116 may put category predictors C1, C4 into set 506 as category predictors C1, C4 have different predictions as original category 502.

FIG. 6 depicts a block diagram 600 of components of computing device 102 in accordance with an illustrative embodiment of the present disclosure. It should be appreciated that FIG. 6 provides only an illustration of one implementation and does not imply any limitations with regard to the environments in which different embodiments may be implemented. Many modifications to the depicted environment may be made.

Computing device 102 may include communications fabric 602, which provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of computer processor(s) 604 by holding recently accessed data, and data near accessed data, from memory 606.

Prediction analysis module 110 may be stored in persistent storage 608 and in memory 606 for execution by one or more of the respective computer processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Prediction analysis module 110 may be downloaded to persistent storage 608 through communications unit 610.

I/O interface(s) 612 allows for input and output of data with other devices that may be connected to computing device 102. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention, e.g., prediction analysis module 110 can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method comprising:
receiving, by one or more processors, a case as an input to a pre-trained model for a prediction, the prediction being based on a plurality of predictors;
determining, by one or more processors, a range for a predictor where the predictor varies without changing the prediction;
generating, by one or more processors, a data set by sampling data across the determined range of the predictor;
building, by one or more processors, a predictive model with the generated data set; and
outputting, by one or more processors, a prediction result including an insight about the range of the predictor.

2. The computer-implemented method of claim 1, wherein determining the range for the predictor comprises:
keeping values of other predictors in the plurality of predictors fixed;
increasing a first initial value for an upper boundary by a pre-defined amount for the predictor under process;
continuing to increase the first initial value by the pre-defined amount for the predictor until the prediction of the case is changed;
determining the increased value as the upper boundary of the range;
decreasing a second initial value of a lower boundary by a pre-defined amount for the predictor under process;
continuing to decrease the second initial value by the pre-defined amount for the predictor until the prediction of the case is changed; and
determining the decreased value as the lower boundary of the range.

3. The computer-implemented method of claim 1, wherein generating the data set comprises:
generating the data set by sampling data across the determined range of the predictor;
sampling the data set that falls within the range and outside the range with equal probability; and
generating the data set repeatedly in such a sampling process until a pre-defined number of the data samples obtained.

4. The computer-implemented method of claim 1, wherein building the predictive model comprises:
building the predictive model wherein the predictive model provides the measurement of predictor importance, the measure of predictor importance based on contribution of the predictors to the prediction;
selecting a number of top ranked predictors based on the measurement; and
refining the ranges of the number of top ranked predictors with an iteration process until a stopping rule is satisfied.

5. The computer-implemented method of claim 1, wherein the stopping rule is selected from the group consisting of: iteration number, convergency of ranges, and user interruption.

6. The computer-implemented method of claim 1, further comprising outputting the range of the predictor.

7. The computer-implemented method of claim 1, wherein the predictor is a continuous predictor with intervals.

8. A computer program product comprising:
one or more computer readable storage media, and program instructions collectively stored on the one or more computer readable storage media, the program instructions comprising:
program instructions to receive a case as an input to a pre-trained model for a prediction, the prediction being based on a plurality of predictors;
program instructions to determine a range for a predictor where the predictor varies without changing the prediction;
program instructions to generate a data set by sampling data across the determined range of the predictor;
program instructions to build a predictive model with the generated data set; and
program instructions to output a prediction result including an insight about the range of the predictor.

9. The computer program product of claim 8, wherein program instructions to determine the range for the predictor comprise:
program instructions to keep values of other predictors in the plurality of predictors fixed;
program instructions to increase a first initial value for an upper boundary by a pre-defined amount for the predictor under process;
program instructions to continue to increase the first initial value by the pre-defined amount for the predictor until the prediction of the case is changed;
program instructions to determine the increased value as the upper boundary of the range;
program instructions to decrease a second initial value of a lower boundary by a pre-defined amount for the predictor under process;
program instructions to continue to decrease the second initial value by the pre-defined amount for the predictor until the prediction of the case is changed; and
program instructions to determine the decreased value as the lower boundary of the range.

10. The computer program product of claim 8, wherein program instructions to generate the data set comprise:
program instructions to generate the data set by sampling data across the determined range of the predictor;
program instructions to sample the data set that falls within the range and outside the range with equal probability; and
program instructions to generate the data set repeatedly in such a sampling process until a pre-defined number of the data samples obtained.

11. The computer program product of claim 8, wherein program instructions to build the predictive model comprise:
program instructions to build the predictive model wherein the predictive model provides the measurement of predictor importance, the measure of predictor importance based on contribution of the predictors to the prediction;
program instructions to select a number of top ranked predictors based on the measurement; and
program instructions to refine the ranges of the number of top ranked predictors with an iteration process until a stopping rule is satisfied.

12. The computer program product of claim 8, wherein the stopping rule is selected from the group consisting of: iteration number, convergency of ranges, and user interruption.

13. The computer program product of claim 8, further comprising program instructions to output the range of the predictor.

14. The computer program product of claim 8, wherein the predictor is a continuous predictor with intervals.

15. A computer system comprising:
one or more computer processors, one or more computer readable storage media, and program instructions stored on the one or more computer readable storage media for execution by at least one of the one or more computer processors, the program instructions comprising:
program instructions to receive a case as an input to a pre-trained model for a prediction, the prediction being based on a plurality of predictors;
program instructions to determine a range for a predictor where the predictor varies without changing the prediction;
program instructions to generate a data set by sampling data across the determined range of the predictor;
program instructions to build a predictive model with the generated data set; and
program instructions to output a prediction result including an insight about the range of the predictor.

16. The computer system of claim 15, wherein program instructions to determine the range for the predictor comprise:
program instructions to keep values of other predictors in the plurality of predictors fixed;
program instructions to increase a first initial value for an upper boundary by a pre-defined amount for the predictor under process;
program instructions to continue to increase the first initial value by the pre-defined amount for the predictor until the prediction of the case is changed;
program instructions to determine the increased value as the upper boundary of the range;
program instructions to decrease a second initial value of a lower boundary by a pre-defined amount for the predictor under process;
program instructions to continue to decrease the second initial value by the pre-defined amount for the predictor until the prediction of the case is changed; and
program instructions to determine the decreased value as the lower boundary of the range.

17. The computer system of claim 15, wherein program instructions to generate the data set comprise:
program instructions to generate the data set by sampling data across the determined range of the predictor;
program instructions to sample the data set that falls within the range and outside the range with equal probability; and
program instructions to generate the data set repeatedly in such a sampling process until a pre-defined number of the data samples obtained.

18. The computer system of claim 15, wherein program instructions to build the predictive model comprise:
program instructions to build the predictive model wherein the predictive model provides the measurement of predictor importance, the measure of predictor importance based on contribution of the predictors to the prediction;
program instructions to select a number of top ranked predictors based on the measurement; and
program instructions to refine the ranges of the number of top ranked predictors with an iteration process until a stopping rule is satisfied.

19. The computer system of claim 15, wherein the stopping rule is selected from the group consisting of: iteration number, convergency of ranges, and user interruption.

20. The computer system of claim 15, further comprising program instructions to output the range of the predictor.
